(19) United States
(12) Patent Application Publication
(10) Pub. No.: US 2004/0135933 A1
(43) Pub. Date: Jul. 15, 2004

(54) Light guide plate and method for fabricating the same

(76) Inventors: Charles Leu, Fremont, CA (US); Ming-Hsuan Liu, Tu-Chen (TW); Ga-Lane Chen, Fremont, CA (US); Tai-Cheng Yu, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/745,111

(22) Filed: Dec. 22, 2003

(30) Foreign Application Priority Data
Dec. 20, 2002 (TW) 91136967

(51) Int. Cl. G02F 1/1335

(52) U.S. Cl. 349/61

(57) ABSTRACT

The present invention provides a light guide plate (10) including a transparent plate (20) and a plurality of dots (221). The transparent plate includes an emitting surface (21), and a bottom surface (22) opposite to the emitting surface. The dots are distributed on the bottom surface of the transparent plate. The emitting surface has a predetermined roughness.

### BACKGROUND OF THE INVENTION

1. Field of the Invention

The present invention relates to light guide plates used in liquid crystal displays, and to methods for fabricating light guide plates.

2. Description of the Prior Art

A liquid crystal display is capable of displaying a clear and sharp image through millions of pixels of image elements. It has thus been applied to various electronic equipment in which a messages or pictures need to be displayed, such as in mobile phones and notebook computers. However, liquid crystals in the liquid crystal display do not themselves emit light. Rather, the liquid crystals have to be lit up by a light source so as to clearly and sharply display text and images. The light source may be ambient light, or part of a backlight system attached to the liquid crystal display.

A conventional backlight system generally comprises a plurality of components, such as a light source, a reflective plate, a light guide plate, a diffusion plate, and a prism layer. Among these components, it is generally believed that the light guide plate is the most crucial component in determining the performance of the backlight system. The light guide plate serves as an instrument for receiving light beams from the light source, and for evenly distributing the light beams over the entire light guide plate through reflection and diffusion. In order to keep light evenly distributed over an entire surface of the associated liquid crystal display, the diffusion plate is generally arranged on top of the light guide plate.

Taiwan Patent Publication No. 486101 issued on May 1, 2002 discloses a backlight system, which is represented in FIG. 7. The backlight system 100 generally comprises a prism layer 130, a diffusion plate 120, a light guide plate 110, and a linear light source 140. The linear light source 140 is arranged at a side of the light guide plate 110. The prism layer 130 comprises first and second prism plates 131, 133. Light beams from the light source 140 are directed to emit from a surface of the diffusion plate 120 via the light guide plate 110. The emitted light beams eventually penetrate the prism layer 130.

The light guide plate 110 further includes a reflective layer 150 deposited on a bottom thereof by means of sputtering.

The backlight system 100 is provided with the diffusion plate 120 so that the light beams are evenly distributed and can provide uniform luminance. However, the diffusion plate 120 is an extra element that adds to costs of raw materials and costs of manufacturing. In addition, when the light beams travel from the light guide plate 110 and from the diffusion plate 120, they must cross two interfaces. Each interface has two media with different reflective indices. Portions of the light beams are reflected and absorbed, and the luminance of the backlight system 100 is reduced accordingly. As a result, optical performance of the backlight system 100 is diminished.

### SUMMARY OF THE INVENTION

It is therefore an objective of the present invention to provide a light guide plate which provides excellent diffusion of light.

In order to achieve the above objective, a light guide plate in accordance with the present invention includes a transparent plate and a plurality of dots. The transparent plate includes an emitting surface, and a bottom surface opposite to the bottom surface. The dots are distributed on the emitting surface of the transparent plate. The emitting surface has a predetermined roughness.

The light guide plate in accordance with the present invention includes a plurality of dots which can scatter and reflect the incident light beams, so as to totally eliminate internal reflection of the light beams and make the light beams evenly emit from the emitting surface of the transparent plate. Moreover, the emitting surface of the light guide plate is precisely polished to achieve a predetermined roughness, so that the emitting surface can diffuse light beams having uneven brightness that are received from the dots. This makes the brightness of the emitting light beams more uniform.

According to another aspect of the present invention, a method for fabricating a light guide plate is provided. The method includes the steps of providing a transparent plate having an emitting surface and a bottom surface opposite to the emitting surface, forming a plurality of dots on the bottom surface of the transparent plate, and precisely polishing the emitting surface of the transparent plate.

Other objects, advantages and novel features of the present invention will be apparent from the following detailed description of preferred embodiments thereof with reference to the attached drawings, in which:

### BRIEF DESCRIPTION OF THE DRAWINGS

FIG. 1 is a side elevation of a transparent plate provided in a method for fabricating a light guide plate in accordance with the present invention;

FIG. 2 is a side elevation of dots formed on the transparent plate of FIG. 1;

FIG. 3 is an isometric view of the transparent plate of FIG. 2 with an emitting surface thereof precisely polished to a predetermined roughness; and

FIG. 4 is a schematic, exploded, side elevation of a conventional backlight system, showing light paths thereof.

### DETAILED DESCRIPTION OF THE PREFERRED EMBODIMENTS

Referring to FIG. 3, a light guide plate 10 in accordance with a preferred embodiment of the present invention includes a transparent plate 20 on which a plurality of bulgy dots 221 is formed. The transparent plate 20 is generally a flat panel made from polymethyl methacrylate (PMMA). The transparent plate 20 includes an incident surface (not labeled), an emitting surface 21, and a bottom surface 22. The incident surface faces a light source (not shown), and receives light beams from the light source. The introduced light beams from the incident surface are then directed to and emitted from the emitting surface 21. The incident surface is perpendicular to the bottom surface 22, while the emitting surface 21 is opposite to the bottom surface 22.

The dots 221 are evenly distributed on the bottom surface 22 of the transparent plate 20. The dots 221 are made of a material having a high light scattering ratio. The dots 221 diffuse light beams coming from the incident surface of the light guide plate 10, so that the light beams are evenly emitted from the emitting surface 21.

The dots 221 are generally cylindrical, hemispherical, tetrahedral, parallelepiped or frustum-shaped. The dots 221 help diffuse complete reflection of the light beams within the light guide plate 10. That is, incident light beams traveling to the dots 221 are diverted so that they emit from the emitting surface 21 of the light guide plate 10 instead of being reflected therefrom. The dots 221 face outwardly away from the bottom surface 22.

The emitting surface 21 of the transparent plate 20 has a predetermined roughness formed by precise polishing.

In summary, the present invention provides a light guide plate 20 having the dots 221. The dots 221 can scatter and reflect the incident light beams to eliminate full-reflection components of the light beams and make the light beams emit uniformly from the emitting surface 21 of the transparent plate 20, in order to provide an efficacious plane light source. Moreover, the light guide plate 20 is precisely polished to achieve a predetermined roughness, which can diffuse light beams having uneven brightness that are received from the dots 221. This makes the brightness of the emitting light beams more uniform.

A method for fabricating a light guide plate in accordance with the present invention includes steps of providing a transparent plate, forming a plurality of dots on the transparent plate, and precisely polishing the transparent plate.

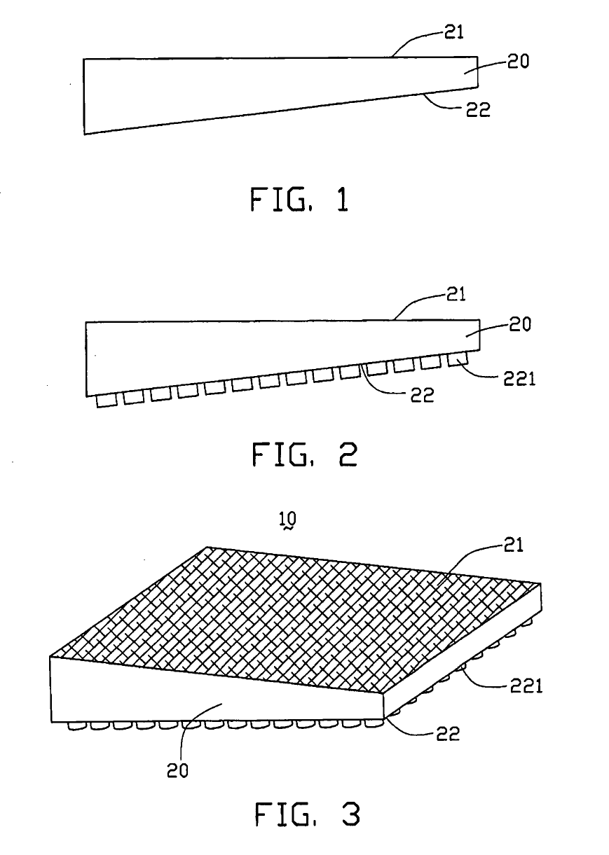

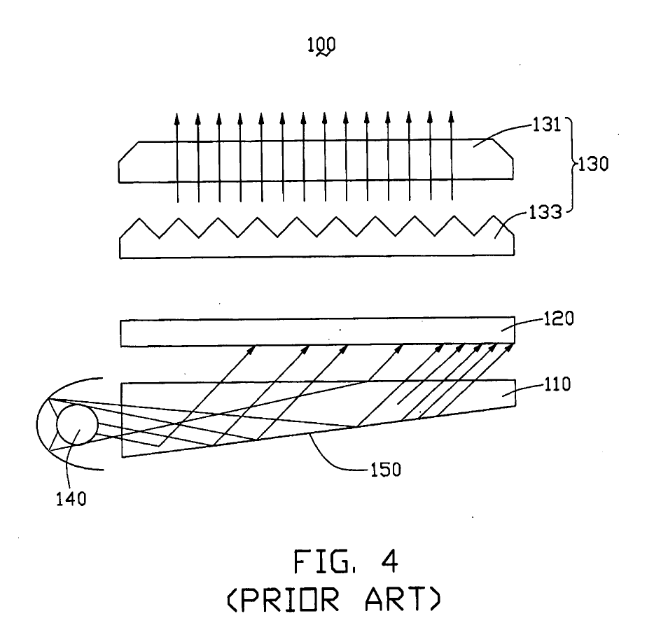

Referring to FIG. 1, first, the transparent plate 20 having the emitting surface 21 and the bottom surface 22 opposite to the emitting surface 21 is provided. The transparent plate 20 is cuneiform, and is made of transparent synthetic resin or glass.

Referring to FIG. 2, the plurality of dots 221 on the bottom surface 22 of the transparent plate 20 is then formed using a printing process. The dots 221 are made of a high-reflexive material, and are generally cylindrical, hemispherical, tetrahedral, parallelepiped or frustum-shaped. The dots 221 can scatter and reflect incident light beams, so as to eliminate totally internal reflection of the light beams and make the light beams evenly emit from the emitting surface 21 of the transparent plate 20.

Referring to FIG. 3, the transparent plate 20 is placed onto a polishing machine (not shown). The emitting surface 21 of the transparent plate 20 is precisely polished to achieve a predetermined roughness, so as to diffuse light beams having uneven brightness that are received from the dots 221. A rotating speed of the polishing step is in the range from 2˜20 rpm, preferably in the range from 5˜10 rpm. The polishing agent used is Al₂O₃ powder, which is mixed with H₂O in relative proportions in the range from 1:3˜1:25 by weight, and preferably in relative proportions of 1:8 by weight. Diameters of particles of the Al₂O₃ powder are in the range from 0.05˜25 μm, and preferably in the range from 0.2˜15 μm. A polishing time is in the range from 2˜10,000 seconds, and preferably in the range from 200˜3600 seconds. A vertical pressure of the polishing operation is in the range from 9.8˜98 kg/m², and preferably in the range from 29.4˜49 kg/m².

The present invention has numerous other possible embodiments, including the following. The light guide plate may have a rectangular cross-section instead of being cuneiform. The method of forming the dots 221 may be by way of chemical etching or mechanical die-casting instead of a printing process. The polishing agent Al₂O₃ used in the precise polishing step may be replaced by SiO₂, Ce₂O₅ or CeO₂ powder, which is mixed with H₂O in relative proportions in the range from 1:3˜1:25 by weight, and preferably in relative proportions of 1:10 by weight. Diameters of particles of the SiO₂, Ce₂O₅ or CeO₂ powder are in the range from 0.05˜25 μm, and preferably in the range from 0.2˜15 μm.

It is to be further understood that even though numerous characteristics and advantages of the present invention have been set out in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

We claim:

1. A light guide plate comprising:
a transparent plate comprising an emitting surface and a bottom surface opposite to the emitting surface, wherein the emitting surface has a predetermined roughness; and
a plurality of dots provided on the bottom surface of the transparent plate.

2. The light guide plate as recited in claim 1, wherein the transparent plate is cuneiform or has a rectangular cross-section.

3. A method for fabricating a light guide plate, comprising the steps of:
providing a transparent plate comprising an emitting surface and a bottom surface opposite to the emitting surface;
forming a plurality of dots on the bottom surface of the transparent plate; and
precisely polishing the emitting surface of the transparent plate so that the emitting surface has a predetermined roughness.

4. The method for fabricating a light guide plate as recited in claim 3, wherein a rotating speed of the polishing operation is 2˜20 rpm.

5. The method for fabricating a light guide plate as recited in claim 3, wherein a polishing time is in the range from 2˜10,000 seconds.

6. The method for fabricating a light guide plate as recited in claim 3, wherein a vertical pressure of the polishing operation is in the range from 9.8˜98 kg/m².

7. The method for fabricating a light guide plate as recited in claim 3, wherein the polishing agent is Al₂O₃ powder mixed with H₂O.

8. The method for fabricating a light guide plate as recited in claim 7, wherein the Al₂O₃ powder and H₂O are mixed in relative proportions in the range from 1:3˜1:25 by weight.

9. The method for fabricating a light guide plate as recited in claim 7, wherein diameters of particles of the Al₂O₃ powder are in the range from 0.05˜25 μm.

10. The method for fabricating a light guide plate as recited in claim 3, wherein the polishing agent is SiO₂ powder mixed with H₂O.

11. The method for fabricating a light guide plate as recited in claim 10, wherein the SiO₂ powder is mixed with H₂O in relative proportions in the range from 1:3˜1:25 by weight.

12. The method for fabricating a light guide plate as recited in claim 10, wherein diameters of particles of the SiO₂ powder are in the range from 0.05˜25 μm.

13. The method for fabricating a light guide plate as recited in claim 3, wherein the polishing agent is Ce₂O₅ powder mixed with H₂O.

14. The method for fabricating a light guide plate as recited in claim 13, wherein the SiO₂ powder is mixed with H₂O in relative proportions in the range from 1:3˜1:25 by weight.

15. The method for fabricating a light guide plate as recited in claim 13, wherein diameters of particles of the SiO₂ powder are in the range from 0.05˜25 gm.

16. The method for fabricating a light guide plate as recited in claim 3, wherein the polishing agent is CeO₂ powder mixed with H₂O.

17. The method for fabricating a light guide plate as recited in claim 16, wherein the CeO₂ powder is mixed with H₂O in relative proportions in the range from 1:3˜1:25 by weight.

18. The method for fabricating a light guide plate as recited in claim 16, wherein diameters of particles of the CeO₂ powder are in the range from 0.05˜25 μm.

19. The method for fabricating a light guide plate as recited in claim 3, wherein the dots is formed by a printing process, chemical etching, or mechanical die-casting.

20. A method of transmitting light in a liquid crystal display, comprising steps of providing a transparent plate including an emitting surface and a bottom surface opposite to the emitting surface, wherein the bottom surface reflects light toward the emitting surface, and the emitting surface is designedly coarse to perform a diffusion function so as to optionally omit a diffusion plate which is conventionally disposed upon the emitting surface.
